(19) United States
(12) Patent Application Publication
(10) Pub. No.: US 2016/0006511 A1
(43) Pub. Date: Jan. 7, 2016

(54) METRO-CORE NETWORK LAYER SYSTEM AND METHOD

(71) Applicant: The Provost, Fellows, Foundation Scholars, & the other members of Board, of the College of the Holy, Dublin (IE)

(72) Inventor: Frank SLYNE, Dublin (IE)

(73) Assignee: The Provost, Fellows, Foundation Scholars, & the other members of Board, of the College of the Holy, Dublin (IE)

(21) Appl. No.: 14/793,471

(22) Filed: Jul. 7, 2015

(30) Foreign Application Priority Data
Jul. 7, 2014 (GB) 1412069.5

(51) Int. Cl. H04B 10/27; H04L 29/12

(52) U.S. Cl. CPC H04B 10/27; H04L 61/2503

(57) ABSTRACT

The invention provides a flat Layer 2 Metro-Core network as part of a Long Reach PON architecture that meets the demands of scalability, efficiency and economy within a modern Telecommunications network. The invention provides for Mac Address Translation applied to layer 2. This allows layer 2 address space to be structured and fits well with the table driven approach of OpenFlow and the wider Software Defined Networks.

The application claims foreign priority benefits to United Kingdom Patent Application No. GB 1412069.5, filed 7 Jul. 2014, which is hereby incorporated herein by reference in its entirety.

### BACKGROUND OF THE INVENTION

1. Field of the Invention

The invention relates to a metro-core network layer and method. In particular the invention relates to a layer architecture that meets the demands of scalability, efficiency and economy within a modern Telecommunications network.

2. Description of the Related Art

Modern communication systems such as Telephone networks, Internet, LANs and WANS operate based on a stack such as TCP/IP (or less commonly, OSI), which extend from the physical layer through the network and transport layer to the application layers. End to End communication may travel through various stacks and partial stacks. The IP network layer of TCP/IP has been the standard protocol used across almost all modern communications networks and data centres, irrespective of the underlying physical and media layers. The use of each layer in the stack requires its own dedicated devices (such as routers, switches, gateways), so the more layers that are used to transfer data means more expenditure in investment, energy and other resources. Also data must be transferred across layers in the stack causing transformational artefacts such as delays. By default, the solution to many communication and interface problems is to pass the data up to the IP layer where there are many technological solutions. This has made the functionality of IP layer devices such as routers very bloated. The success of the internet has actually frozen innovation since communications providers prefer to invest in technology that has proven to work.

With the advent of optical fibre technology in the access and core networks of telecommunications companies, and the availability of lower cost open switches based on the principles of Software Defined Networking (SDN), there is an opportunity to design robust communications that operate using the lowest layers of the stack, physical (optical) layer (Layer 1) and the data link layer (Layer 2).

Wide Area communications systems require packetisation/multiplexing of data, universally unique addressability of end points which unfortunately Layer 1 (in particular optical) networks are not equipped to support. Layer 2, of which Ethernet is a dominant example, does provide packetisation/multiplexing of data and universally unique addressability of end points. A main problem is that the structure of the Layer 2 addressing scheme is random so as to make it unusable in a wide-area, multi-purpose, context. Ethernet works well in a LAN environment with switches and hubs being used to direct traffic to/from particular hosts and segments, however it does not work well for spanning different layers in a telecommunications network.

It is therefore an object to provide an improved metro-core network layer and method for use in a telecommunications system.

### BRIEF SUMMARY OF THE INVENTION

According to the invention there is provided, as set out in the appended claims, a telecommunications network comprising:
a passive optical network comprising an address translation module to operate at a layer 2 address space.

The invention provides a structure to the Layer 2 addressing in a modern Telecommunications network (spanning access, metro and core portions) so that data can be switched or effectively routed over a wide area as would happen at the traditional Layer 3 level. The invention provides benefits of savings in energy, reduction in device count and performance improvement, there should be other opportunities such as direct control and monitoring of Quality of Service.

In one embodiment the address translation module is configured to allow layer 2 address space to be structured.

In one embodiment there is provided a control layer for use in a passive optical layer comprising an address translation module to operate at layer 2 address space.

In one embodiment there is provided a method of operating a passive optical network comprising the step of providing a MAC address translation module to operate at a layer 2 address space. A MAC address is a media access control address (MAC address) which can be classed as a unique identifier assigned to network interfaces for communications on the physical network segment. MAC addresses are used as a network address for most network technologies, including Ethernet and WiFi.

Conducting data communications at lower levels will provide major improvements in energy consumption and reduction of excessive buffering of packets.

The invention provides a large scale flat network that can be created and run entirely at a layer 2 level. This provides significant benefits in terms of energy saving, complexity of design for operations, resilience and redundancy.

It will be appreciated that the invention provides a number of advantages, such as:

End devices are identified directly at a lower level in the network i.e. at Layer 2. Secure. Services bind to devices rather than other way around.

Binding between real and pseudo MAC addresses is controlled by a simple uncomplicated infrastructure, or by a delegated party. This binding is unique can be done quickly and can also be removed/changed quickly. This binding is unique and prevents duplication or take-over of mapping by third parties.

MAC address translation facility can be operated by infrastructure provider. As a common broker between higher level network providers and/or service providers. Utilisation of lower layer infrastructure resources is efficient and economic. Tenant network providers leases capacity required. This leads to much sought after Open Access.

MAC address translation at the last hop in the network (GEM port) allows binding of services to be changed quickly. Service characteristics can be carried with a device, if they move between locations or between termination nodes (ONU's). This allows services such as tablet or phone moving from a broadband line to a wifi or Cable modem, or another building, and carry service characteristics with them (e.g. speed, authenticated services, ip address etc.).

MAC address translation can be used on any network that uses Ethernet as a Layer 2 carrier. Ethernet is ubiquitous and is found on all LAN's, WAN's, PON sub-layers, mobile LTE, DOCSIS cable TV networks, Wifi. The same principles as described for Optical networks can be applied to these networks. This supports principle of open access and efficient use of infrastructure.

A ubiquitous packet based Layer 2 network is provided by the invention. Subscription to services does not need to done at the level of an entire household or business premises, nor does it need to be time-based. One device can be accessing a service (e.g. Video-On-Demand) from one service provider, at one quality of service. A separate device can be accessing a different service provider at a separate quality of service.

Service binding at Layer 2, is backwardly and forwardly compatible with existing layer 3 services.

Structured addressing and binding. The customer network environment can be extended to include a centralised data centre portion. This allows services (such as firewalling, parental access control) to be hosted in a virtual manner, efficiently and securely by the service provider

Layer 2 network provides low latency, less buffering of traffic, lower jitter, Higher quality of high speed transmission.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates a reference Architecture where a 48 bit pseudo MAC is apportioned between various devices along the path of traffic between a data source and a Access Termination node;

FIG. 2 illustrates a reference Architecture according to another embodiment of the invention;

FIG. 3 illustrates a Structured Layer 2 Addressing, and the Mapping between ONUs, T-CONTs and GEM Ports according to one embodiment;

FIG. 4 illustrates a resultant Flat Layer 2 network as designing using a FLATLANd (acronym for Flat Layer Two Large-scale Network) architecture, according to one embodiment;

FIG. 5 illustrates a Client Registration process through the FLATLANd architecture; and

FIG. 6 illustrates a FLATLANd Rebind Service Profile sequence according to one embodiment.

### DETAILED DESCRIPTION OF THE INVENTION

The challenge the present invention overcomes is to design a large scale layer 2 network that not only binds service providers with their customers, but is also efficient and economic. The default solution is to pass the challenge of network slicing to a higher layer through the use of tunnels, VPNs, tags or labels. Examples of research into large scale layer 2 networks in the Telecoms world as well as in Data Centres include EU FP-7 Project SPARC where MPLS labels are used to bind service provider and customer groupings. See EU-FP7. SPARC—Split Architecture Carrier Grade Networks. 2010; Available from: http://www.fp7-sparc.eu/.

In Project NANDO (Neutral Access), network slicing is created using VLANs, see Matias, J., et al., ‘Towards Neutrality in Access Networks: A NANDO Deployment with OpenFlow, 2011’. This provides the benefit of simplicity from the perspective of encapsulation and working across different media, however it has a significant downside. Inclusion in the VLAN is based on a service provider supplied secondary MAC address that must be associated with each device that requires access.

Substantial progress on creating flat, large-scale Layer 2 networks has been achieved in the area of Data Centres. In modern Data Centers, not only are there tens if not hundreds of thousands of physical machines, but each machine can have up to twenty virtual machines each of which must be addressable through a distinct layer 2 MAC address. The different strategies include IEEE TRILL Shortest Path Bridge (SPB), VL2, Portland, SEATTLE, Hedera, and BCube.

The first four of these span the gamut of what is currently being tested and going through standardisation, see DeCusatis, C. J. S., A. Carranza, and C. M. DeCusatis, Communication within Clouds: Open Standards and Proprietary Protocols for Data Center Networking IEEE Communications Magazine, 2011. TRILL uses a layer 2 link state protocol to identify the shortest paths between switches on a hop-by-hop basis, and load balance across these paths. This enhances scalability, allows loop-free multipath topologies and reduces excessively large MAC address tables (approaching 20,000 entries) that must be discovered and updated in conventional Ethernet networks. Shortest path bridging (SPB) is a layer 2 standard (IEEE 802.1aq) that attempts to address the same basic issue as TRILL, albeit in a slightly different approach. It uses the IEEE 802.1ah PBB provider link state bridging. The 802.1ah frame format provides a service identifier that is completely separate from the backbone MAC addresses and the VLAN IDs. This separates the connectivity services layer from the physical network infrastructure.

VL2 uses a CLOS network topology with Valiant Load Balancing (VLB) with traffic being sent to random intermediate switches, resulting in small forwarding tables and hosts which can be independent of location in the data centre. Each Core switch is given the same Anycast address and ECMP is used to select a random shortest paths. OSPF builds forwarding tables between the switches each of which is assigned a location-specific IP address. Real servers have Application-specific IP addresses so a centralised address manager is needed to maintain the mappings between Application and Local IP address mappings. In order to route on Local Addresses and deliver based on Application specific Addresses, IP-in-IP encapsulation is used. This requires a layer 2.5 stack which run on each host in the VL2 regime, that consults the Address Manager for the mapping between the Application and Local IP address mappings prior to transmitting packets.

Portland uses a fat tree topology with pseudo or position-based MAC (PMAC) addresses to achieve a very compact routing state, Tavakoli, A., et al., Applying NOX to the Datacenter, 2009. Top of the Rack aggregation switches are grouped together in pods, with every core switch being connected to every pod through a single link. Each Virtual Machine and real host is assigned a pseudo MAC address with information embedded related to the Pod identifier, its position in the pod, the port identifier and lastly it's Virtual Machine Identifier. Typical this of the form: pod.position.port.vmid. By having a structured and predictable regime, as opposed to a typically random layer 2 addressing, opens up the possibility of best of Layer 2 and Layer 3 worlds. Wild carding of addresses can be used to route to pods, at a layer 2 level. Longest prefix-matches can be used to reduce forwarding state. Three components are needed to make the Portland strategy work. Firstly, in order to obviate the need for hosts and VMs to be aware of the top-level addressing structure, switches must rewrite between pseudo and real MAC addresses. Secondly, in order to calculate routes locally, switches must maintain a matrix of full link-connectivity. Lastly, a centralised fabric manager is required to maintain the mappings between pseudo and real MAC addresses.

There are two main distinguishing differences between the scenarios of the data centre networks and the Passive Optical networks. Firstly, traffic is predominantly consumed by the PON access termination nodes (customer devices) whereas in the Data Centre, traffic is generated by the access termination nodes (Data Centre machines). Secondly, and most crucially, PON access nodes are not under the control of the PON operator. This strictly precludes schemes that use secondary MAC addresses (NANDO) and IP-in-IP encapsulation (VL2). While there is a need for customised components in SPB, Trill and Portland, the scale of Trill and SPB is limited by PBB encapsulation. In the case of Portland, the range of pseudo MAC addresses is relatively unbounded (2̂48).

The approach allows an efficient hierarchy of layer 2 switches or distributed Openflow tables (across ONU/OLT, Electrical switches and Optical) to be built up. Applying Layer 3 analogies even further, the layer 2 network can be treated as routable with in the Metro-Core domain.

One of the main deciding points is where to conduct the Address Translation. This could be at the Electrical Switch, the OLT or even the ONU. Software Defined Networks (SDN) can assist, in that it allows tasks quite easily what are difficult to do with traditional routers and switches, such as the Open Access and Layer 2 routing concepts presented above, see Parulkar, G., et al., Virtualized network infrastructure using OpenFlow, 2010. This is because Software Defined Networks (SDN) separate the control and data planes in network components such as switches, bridges and routers, see Koldehofe, B., et al. The power of software-defined networking: line-rate content-based routing using OpenFlow in Proceedings of the 7th Workshop on Middleware for Next Generation Internet Computing. 2012. ACM.

OpenFlow is the most widely known protocol for SDN networks enabling the controller to interact with the forwarding plane of the switches. Messages from switches inform the controller when links go down or when a packet arrives with no specified forwarding instructions. The forwarding instructions are based on a flow entry, which is defined by a set of specific parameters, such as source and destination Ethernet/IP addresses, switch input port, VLAN tag, etc. The controller can specify the set of parameters and how packets that match the flow entry should be processed.

The topology that needs to be configured within Long Reach PON network can be described as follows. In the Flat Core of the LR-PON architecture, the core switches are meshed partially or fully. Metro-Core Nodes perform traffic aggregation closer to the customers. Passive Optical Networks are composed of customer side ONU devices and Metro Access OLT devices, between which the PON protocol runs. In LR-PON, the downstream protocol is based on TDM, while in the upstream traffic is statistically multiplexed. Fairness of usage is maintained using a Dynamic Bandwidth Algorithm (DBA). From a practical Layer 2 perspective, the Ethernet protocol runs throughout the network.

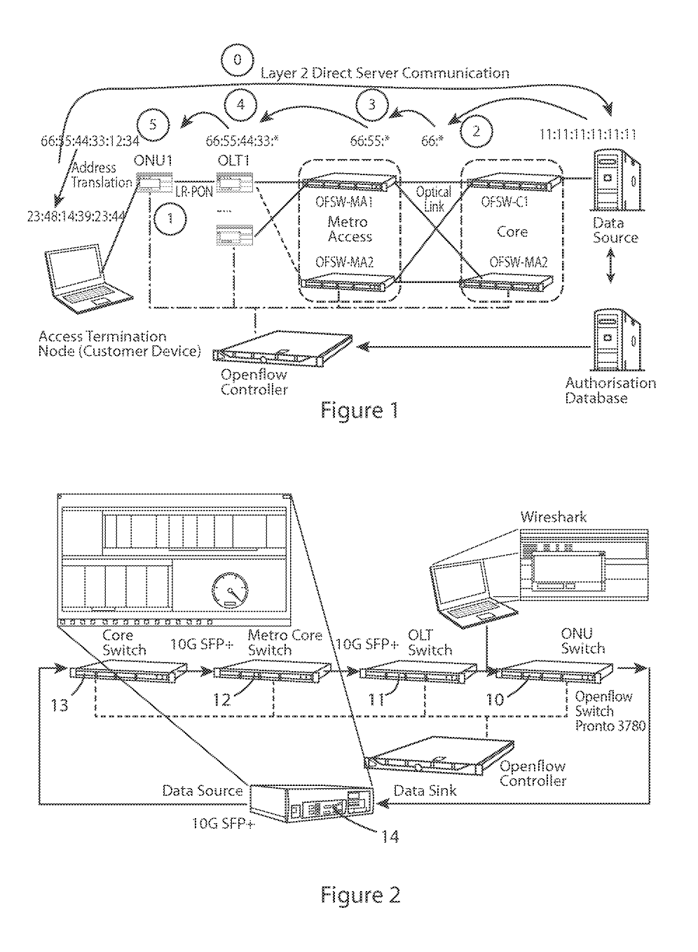

FIG. 1 illustrates a reference Architecture according to one embodiment where a 48 bit pseudo MAC is apportioned between various devices along the path, for example defined by an OFSW, OLT and ONU module, of traffic between a data source and an Access Termination node.

FIG. 2 illustrates a reference architecture according to another embodiment and similar to FIG. 1.

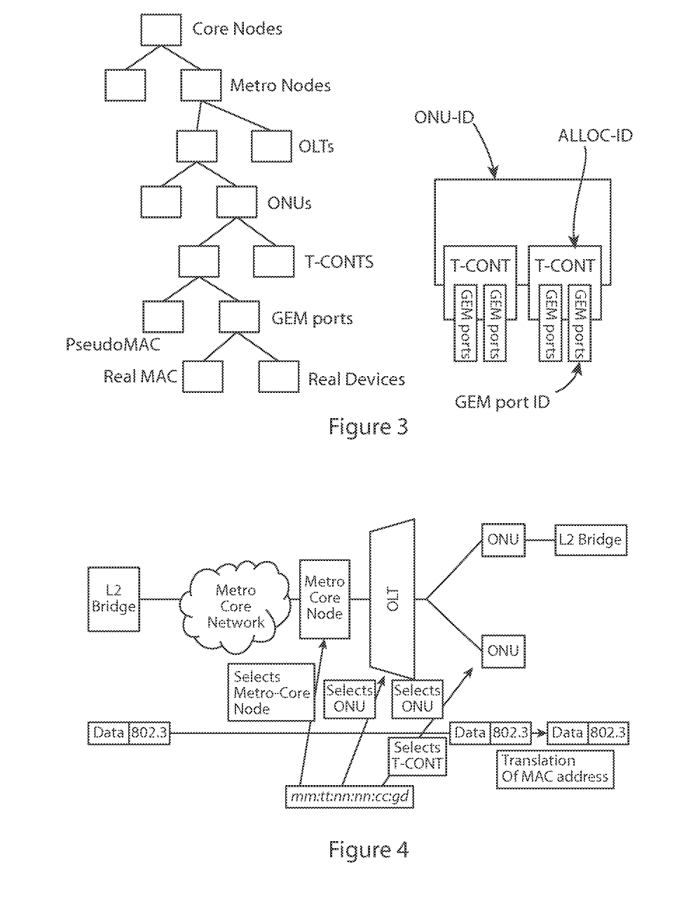

FIG. 3 illustrates a Structured Layer 2 Addressing, and the Mapping between ONUs, T-CONTs and GEM Ports. FIG. 3 shows the relationship between ONU's, T-CONTS and GEM ports. A T-CONT is a group of logical connections that carries traffic within an ONU. Each T-CONT is identified by a unique Alloc-ID and corresponds to a service traffic of one bandwidth type and QoS characteristic. Each T-CONT consists of one or more GEM Ports. A GEM Port is a virtual port which encapsulates frames transmitted between the OLT and the ONU. Each traffic-class is assigned a different GEM Port.

FIG. 4 shows a 48 bit pseudo MAC scheme in the fashion mm:tt:nn:nn:cc:gd where mm is the Metro-Core Node identifier, tt is the OLT identifier with respect to the Metro-Core Node. nn:nn is the ONU qualifier, cc is the T-CONT qualifier. Lastly gd is the combined GEM port and device qualifier. There are 4096 Metro-Core Nodes (12 bits), each with 4096 OLT's (12 bits). Each OLT has 4096 ONU's (12 bits). Each ONU can have 16 T-CONTs (4 bits) which corresponds to distinct service traffics, bandwidth types or service providers. Each bandwidth type has its own QoS definition. The remaining 8 bits is split between GEM ports (4 bits or 16 GEM ports per T-CONT) and devices (4 bits or 16 devices per GEM ports). This will allow for example different users on the same ONU to buy services from different providers. While a specific example of address reallocation has been present, such allocation can be modified on-demand to suit the specific network architecture considered.

FIG. 4 shows the Flat Layer 2 network can complete the same objectives of the classical approach presented in FIG. 1. The benefits are the reduction in number of high end (for example MPLS) routers, and the elimination of tunnel connections over PPPoE since the addressing schema is fixed and the Class of Service/Quality of Service Information is inherent in the address structure. A 48 bit pseudo MAC is apportioned between various devices along the path of traffic between a data source and an Access Termination node.

Referring again to FIG. 1 the events at each juncture can be described as follows, according to one embodiment. At step 1, MAC translation is programmed to convert real MAC address to pseudo MAC and vice versa. Currently, this is completed statically:
in_port=1,dl_dst=23:48:14:39:23:48,actions=mod_dl_dst: as
66:55:44:33:22:11,output:2

In practice, the static definition can be replaced by a Link Discovery protocol that would discover the MAC addresses of Access termination nodes. At step 2, a layer 2 frame is to be transmitted from the Data Source (11:11:11:11:11:11) to the Customer Device (23:48:14:39:23:48). The Data Source sees the customer device as 66:55:44:33:22:11. The frame is forwarded by OFSW-C1 to the correct Metro-Core Node OFSW-MA1 according to the openflow rule, which wildcards all except the left-most 12 bits of the MAC address.

in_port=1,dl_dst=66:5f:ff:ff:ff:ff/ff:f0:00:00:00:00, actions=output:2

At step 3, on arrival at OFSW-MA1, the frame is forwarded to the correct OLT according to the openflow rule which wildcards all except the left-most 24 bits of the MAC address

in_port=1,dl_dst=66:55:44:ff:ff:ff/ff:ff:ff:00:00:00, actions=output:2

At step 4, On arrival at OLT1, the frame is forwarded to the correct ONU according to the openflow rule which wildcards all bar the left-most 36 bits of the MAC address

in_port=1,dl_dst=66:55:44:33:2f:ff/ff:ff:ff:ff:f0:00,actions=output:2

At step 5, on arrival at ONU1, the frame is forwarded to the correct openflow rule, which wildcards all bar the left-most 40 bits of the MAC address

in_port=1,dl_dst=66:55:44:33:22:ff/ff:ff:ff:ff:ff:00,actions=output:2

At the last step, the pseudo MAC address is translated to its real equivalent 23:48:14:39:23:48.

The reference architecture can be created using four daisy-chained Openflow switches, acting as ONU, 10 & 11, OLT, Metro-Core 12 and Core Switches 13 in FIG. 2. The switches are based on Pronto 3780 with 48 SFP+ ports each running at 10 Gbps. The switches, 10 to 13, are loaded with their respective static rules for MAC Address Translation (mod_dl_dst) and wild-card MAC pattern based forwarded. A Spirent C1 module 14 both injects traffic at 10 Gbps and monitors the resulting traffic. The Spirent C1 module 14 verifies that traffic is being transmitted at line speed through the testbed. Separately, Wireshark verifies that the layer 2 frames are being functionally manipulated and forwarded correctly.

The system and method of the invention presented brings structure to the layer 2 network, and extends the layer 2 network from information provider out to the customers. This makes the network appropriate for analysis and control by SDN devices in the path of the traffic flows. The system and method of the invention presents savings in the complexity and numbers over traditional routing and switching devices as well as the Operation and Maintenance resources to manage them.

All existing higher layer applications and functions, that traditional run on these networks (such as MPLS, VPNs and IP) continue to function.

### Client Basic Registration

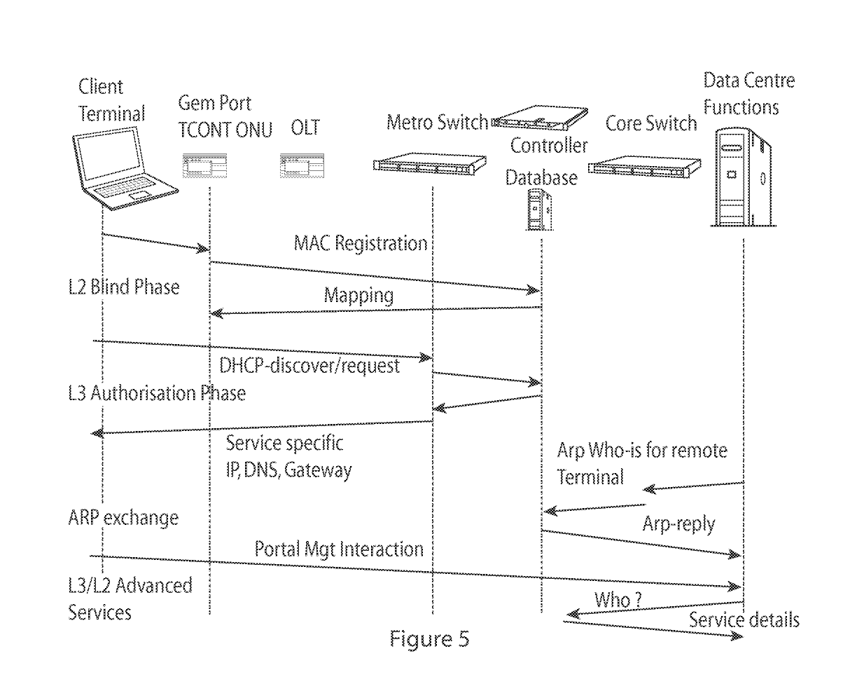

FIG. 5 shows a FLATLANd client binding and registration process as in the Layer 2 Bind Phase, the client device registers its interface on the network. This interface is configured to obtain its IP address from a DHCP server, which in the current design is situated centrally and upstream from the device.

On sensing of a DHCP-discover/request packet with a MAC address for which there is no flow rule, the Layer 2 openflow switch at the Gem Port of the customer ONU, sends the DHCP packet to the centralised Openflow Controller.

The Openflow Controller is configured to perform three actions. Because the Openflow Controller knows the switch from which packet is received the controller formulates a pseudo-MAC address appropriate to that switch. This is assuming that the pool of pseudo-MAC addresses for that switch has not been exhausted. The pseudo-MAC address is bound to the real-MAC address of the device's interface. The binding process within the Openflow Controller database, creates a forward and reverse mapping between the real- and pseudo-MAC addresses to allow fast database lookups. The mapping is then sent to the GEM port switch as an Openflow rule.

In the Layer 3 Authorisation Phase, the client device receives appropriate network layer facilities such as IP address, primary and secondary DNS settings and Gateway IP addresses. The Openflow controller intercepts a DHCP-discover/request either as part of the Layer 2 Bind phase or as a retransmission of this request. Typically, a retransmission happens within 1 to 2 seconds. The Openflow Controller constructs a DHCP-reply packet with the appropriate settings, for transmission back to the Gem Port Layer 2 switch. The client device then receives the DHCP-reply. Because the Openflow Controller, knows the Gem Port switch from which packets are received, the controller can construct the IP addresses, DNS settings which are appropriate Service Provider and service type.

In the ARP Exchange Phase, the end-points exchange IP address and MAC address pairings. Where the client device sends an IP packet to a data centre, the arp who-is requested is broadcast upstream and the upstream device responds with an arp response. The Gem Port switch performs a swap of real- and pseudo-MAC addresses for the client device. Where the data centre sends an IP packet to a client device, the metro switch intercepts the arp who-is request which is destined to the pseudo-MAC of the client device. The client device cannot respond directly, and the controller performs a proxy-arp functionality by constructing an ARP response based on the pseudo-MAC address of the client device.

The centralised Controller contains a complete mapping between pseudo-MAC, real-MAC and IP addresses for all devices on the network. This enables portal applications and service selection gateways to unequivocally identify the source of network activity and services requests in real-time. For example a mapping function can be competed as follows:

Mapper: Registering 00:04:00:00:00:01 to 66:55:44:33:2201 on port 2 switch 00-00-00-00-00-01
DHCP: Discover message from 00:04:00:00:00:01

### DHCP: Granting 10.0.0.1 to 00:04:00:00:00:01

Mapper: Registering 00:04:00:00:00:01 to 66:55:44:33:22:01 on port 2 switch 00-00-00-00-00-01
DHCP: Request message from 00:04:00:00:00:01
Arp Listener: 10.0.0.1 is asking Who Has 10.0.0.2

### Arp Controller: Response to 10.0.0.1 00:04:00:00:00:02 has 10.0.0.2

Arp Listener: 10.0.0.2 is asking Who has 10.0.0.1

### Arp Controller: Response to 10.0.0.2 66:55:44:33:22:01 has 10.0.0.1

Service Profile Enhancement Once an interface of a device has been bound at Layer 2, it is possible to remap the interface to a different service type or indeed service provider. FIG. 5 shows a client which issues a request to the Service Portal to register with enhanced profile, with a profile type as a parameter. The Service Portal has knowledge of the real interface making the request, and proceeds to remap the real-MAC to the next available pseudo-MAC of the requested profile. In order to complete, the rebinding process, the client should execute a DHCP release and request sequence.

### Bandwidth Apportionment

Traditional Service Providers have built dedicated networks so as to differentiate their services from other offerings. Differentiation may be based on factors such as availability and bandwidth. In the current design, since a common infrastructure is shared across all Service Providers, FLATLANd employs mechanisms for bandwidth apportionment that are distributed through the network.

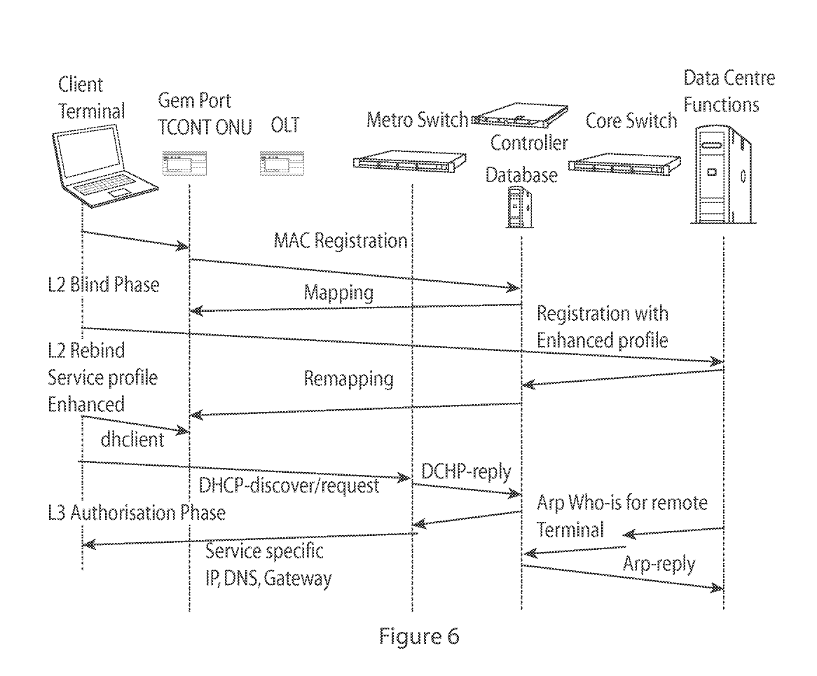

FIG. 6 shows a contiguous 48-bit address range. In the example above 36 bits of the address relate to the routing of traffic across the core and metro networks to an ONU. This is composed of Metro Core, OLT and ONU address portions. 12 bits of the address relate to the identification of Service Provider and Service Type. Bandwidth apportionment may be performed at the root of the network, which has visibility of all traffic flows in the network, however, that would require a contiguous flow table which is unfeasibly large (with potentially 2̂48 entries).

The FLATLANd architecture, according to one embodiment, allows two main approaches for distributed bandwidth apportionment: Geographical and per-Class. Table 1 shows a Geographical control applied to the flows traversing each network element. For example, in order to apportion bandwidth according to a per OLT basis, rules need to be applied at the upstream Metro Core network. The existing flow rules can be modified with the meter tag's on the output action. Table 2 shows per-Class control applied to the flows traversing each network element.

TABLE 1

| Bandwidth | | Downstream |
|---|---|---|
| apportionment | Conducted at | Flows per device |
| Per OLT | Metro Core | 4096 |
| Per ONU | OLT | 4096 |
| Per TCONT | ONU | 4096 |
| Per Service Type | TCONT | 16 |
| Per Service provider | GEM port | 256 |

TABLE 2

| Bandwidth | | Downstream |
|---|---|---|
| apportionment | Conducted at | Flows per device |
| Per Class | Metro Core | 4096 |
| | | 12 bits of SP and |
| | | Service type |
| Per Class | OLT | 4096 |
| | | 12 bits of SP and |
| | | Service type |
| Per Class | ONU | 4095 |
| | | 12 bits of SP and |
| | | Service type |
| Per Class | TCONT | 16 |
| Per Class | GEM port | 256 |

The key difference with the Geographical model, is that distinct flow rules are created for the metering of each class of traffic at each Metro-Core, OLT and ONU's. These are separate from the rules necessary for forwarding flows. The advantage of per-Class bandwidth apportionment is that there is greater control over each Class of service across the network, whereas with Geographical, there is probably more efficient use of bandwidth.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

What is claimed is:

1. A telecommunications network comprising:
a passive optical network comprising an address translation module to operate at a Layer 2 address space.

2. The network of claim 1 wherein the address translation module is configured to allow Layer 2 address space to be structured.

3. The network of claim 1 wherein a device connecting to the network comprises a MAC address and the address translation module is configured to assign a pseudo MAC address to identify said device.

4. The network of claim 1 comprising a client binding and registration module configured to register a device interface on the network, wherein the interface is configured to obtain an assigned IP address from a server.

5. The network of claim 1 wherein a controller is configured to recognise a switch based on a packet of data received and formulate a pseudo-MAC address appropriate to identify said switch.

6. The network of claim 1 wherein an interface of a device is configured to be bound at Layer 2, such that the network can remap the interface to a different service type or service provider.

7. The network of claim 1 comprising a service portal to register a device with an enhanced profile making a request on the network, such that the service portal has knowledge of an interface of the device making the request and configured to remap a real-MAC address to the next available pseudo-MAC address of the requested profile.

8. The network of claim 1 wherein a controller comprises a complete mapping function between pseudo-MAC, real-MAC and IP addresses for a plurality of devices on the network.

9. The network of claim 1 wherein a controller is provided with a mapping function and a database and configured to create forward and/or reverse mapping between a MAC address and a pseudo MAC address to facilitate database lookups to identify the device at Layer 2.

10. A control layer for use in a passive optical layer comprising an address translation module to operate at Layer 2 address space.

11. A method of operating a passive optical network comprising the step of providing a MAC address translation module to operate at a Layer 2 address space.

12. A passive optical network comprising an address translation module to operate at a Layer 2 address space.
